(19) United States
(12) Patent Application Publication
(10) Pub. No.: US 2007/0133611 A1
(43) Pub. Date: Jun. 14, 2007

(54) Method and apparatus of frequency estimation for the downlink of td-scdma systems

(75) Inventors: Yan Li, Shanghai (CN); Luzhou Xu, Shanghai (CN); Yanzhong Dai, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/580,728

(22) PCT Filed: Nov. 29, 2004
(86) PCT No.: PCT/IB04/52587

§ 371 Date: May 24, 2006

(30) Foreign Application Priority Data
Nov. 28, 2003 (CN) 200310115793.3

(51) Int. Cl. H04J 3/06; H04J 13/00

(52) U.S. Cl. 370/503; 370/479

(57) ABSTRACT

A method of frequency estimation for the downlink of wireless communication systems, comprising steps of: determining, according to the received radio signals, the phase shift of the midamble and that of the downlink synchronization code of the radio signals respectively; calculating the phase shift difference between the midamble and the downlink synchronization code of the radio signals, according to the determined phase shift of the midamble and that of the downlink synchronization code; estimating the frequency offset of the radio signals, according to the phase shift difference between the midamble and the downlink synchronization code of the radio signals and the relationship between the expected midamble and the downlink synchronization code, e.g. the time interval between the midamble and the downlink synchronization code in communication protocols.

### FIELD OF THE INVENTION

The present invention relates generally to a method and apparatus of frequency estimation for the downlink of wireless communication systems, and more particularly, to a method and apparatus of frequency estimation for the downlink of TD-SCDMA systems.

### BACKGROUND ART OF THE INVENTION

In typical wireless communication systems, information interaction between the transmitter and the receiver is achieved through data transmission over radio spatial channels. At the transmitter side, the transmitter modulates the user signals to be transmitted on the RF carrier of a channel, to produce RF signals, and then transmits it to radio space via the antenna. At the receiver side, the receiver receives the RF signals from radio space through the antenna, then mixes the received signals with a LO (local oscillator) signals, converts the received RF signals to IF (intermediate frequency), and finally recovers the desired user signals through IF filtering and demodulation.

In the above signals reception procedure, the receiving channel is depended on the frequency of the LO signals in the receiver. Only when the frequency of the LO signals match with the carrier frequency of the desired channel, user signals can be demodulated correctly. A difference between the LO signals and the channel carrier will cause loss of user signals spectrum partly or evenly entirely after IF filtering, and thus lead to serious signals distortion. Moreover, a large frequency offset of the LO signals in the receiver will result in various combination frequency interference, and more particularly, the worsening of image frequency interference will cause decrease the capability of the filter in the system in suppressing the interference. In this way, serious out-of-band interference will be caused in subsequent baseband processing, and thus data recovery is affected.

In order to guarantee reliable data transmission in wireless communication systems, the third-generation partnership project (3GPP) for 3G wireless systems recommends that the accuracy of the LO signal frequency of the UE (user equipment) be accurate within 0.1 ppm compared with the received carrier frequency. So the receiver in UEs oft en adopts AFC (automatic frequency control) scheme to track the carrier frequency changes of the receiving channel, to ensure that the LO frequency can meet 3GPP's requirement for accuracy. FIG. 1 is a block diagram illustrating the closed-loop AFC scheme in the receiver. As shown in FIG. 1, the received signals Rx and the LO signals produced by VCO (voltage controlled oscillator) 102 are multiplied at multiplier 101, to generate signals whose carrier frequency is the frequency difference between the two input signals. If the LO signals produced by the VCO are on the same frequency as the received signals Rx, the output signals of multiplier 101 are the undistorted baseband signals after Rx is down-converted. After being down-converted, the received baseband signals are processed through ADC 103 and AGC 104, the suitable baseband digital signals can be obtained within. the dynamic range. Afterwards, cell search unit 105 selects a suitable cell according to the baseband digital signals, and determines the working parameters of the cell, such as midamble taken as known signals. Then, frequency estimation module 106 compares the baseband digital signals outputted from the AGC with the known signals determined in cell search procedure, and outputs their frequency difference. The output signals of frequency estimation module 106 is digital, and thus needs to be converted into analog signals to control the voltage of VCO 102 so that the frequency of the LO signals outputted by the VCO can keep up with the carrier frequency change of the received signals.

In the architecture of closed-loop AFC as shown in FIG. 1, frequency estimation module 106 is a key element. For different systems, the working principle and architecture of frequency estimation module 106 may be different. For example, in conventional wireless communication systems, frequency estimation module 106 is implemented by using phase shift detection or DFT (Discrete Fourier Transform); in DS-CDMA (FDD) systems, the frequency estimation module can achieve synchronization and frequency estimation by using some special continuous signals (for example, WCDMA(Wideband CDMA) systems use SCH(Synchronization Channel) signals to estimate frequency offset); in the downlink of UMTS-TDD system, frequency estimation can be realized by processing the received know midamble inserted in the CCCH.(Common Control Channel)

The above frequency estimation methods have yielded certain results in practical systems. But in UMTS-TDD system, a long midamble is needed for the frequency estimation procedure to ensure accuracy of the estimation. For instance, in the burst traffic timeslot of a TD-CDMA system with high chip rate of 3.84 chips/s, the midamble is 512 chips in duration. The midamble is first divided into several sequence segments with equal length, and correlation operation is performed in each sequence segment with the known midamble segment. These interim correlation operation results are accumulated and normalized to get the final frequency estimation result. But in a TD-SCDMA system with chip rate at only 1.28 chips/s, the midamble is just 144 chips in duration, not long enough to implement the above segmented frequency estimation algorithm. Additionally, in order to alleviate the impact of multipath interference to the accuracy of frequency estimation in UMTS-TDD system, some complicated operations, such as inverse matrix transform and so on, are necessary to be done during frequency estimation procedure. And this complicated frequency estimation method is not suitable for low-speed TD-SCDMA system either.

Therefore, it's necessary to put forward a simple and fast frequency estimation method to address the characteristics of TD-SCDMA system.

### SUMMARY OF THE INVENTION

An object of the present invention is to provide a fast and simple method to estimate and rectify the frequency offset of the LO signals in the receiver of TD-SCDMA system.

Another object of the present invention is to provide a frequency estimation and rectification method for receivers to attain favorable performance despite the multipath interference.

A method of frequency estimation for the downlink of wireless communication systems in accordance with the present invention, comprises: determining, according to the received radio signals, the phase shift of the midamble and that of the downlink synchronization code of the radio signals respectively; calculating the phase shift difference between the midamble and the downlink synchronization code of the radio signals, according to the determined phase shift of the midamble and that of the downlink synchronization code; estimating the frequency offset of the radio signals, according to the phase shift difference between the midamble and the downlink synchronization code of the radio signals and the relationship between the expected midamble and downlink synchronization code (such as the time interval between the midamble and downlink synchronization code of communication protocols).

An apparatus of frequency estimation for the downlink of wireless communication systems in accordance with the present invention, comprises: a determining unit, for determining, according to the received radio signals, the phase shift of the midamble and that of the downlink synchronization code of the radio signals respectively; a calculating unit, for calculating the phase shift difference between the midamble and the downlink synchronization code of the radio signals, according to the determined phase shift of the midamble and that of the downlink synchronization code; an estimating unit, for estimating the frequency offset of the radio signals, according to the phase shift difference between the midamble and the downlink synchronization code of the radio signals and the relationship between the expected midamble and the downlink synchronization code (such as the time interval between the midamble and downlink synchronization code of communication protocols).

### BRIEF DESCRIPTION OF THE DRAWINGS

For a detailed description of the preferred embodiments of the invention, reference will now be made to the accompanying drawings in which:

FIG. 1 is a block diagram illustrating the closed-loop AFC (automatic frequency control) method implemented in the receiver;

FIG. 2 shows the sub-frame and timeslot structures used in TD-SCDMA system in communication protocols;

FIG. 3 is a flow chart illustrating the frequency estimation in the receiver of TD-SCDMA system in accordance with the present invention;

FIG. 4 is a block diagram illustrating the frequency estimation module in the receiver of TD-SCDMA system in accordance with the present invention,

FIG. 5 is a block diagram illustrating the Rake receiver with the frequency estimation module proposed in the present invention.

### DETAILED DESCRIPTION OF THE INVENTION

According to the feature that midamble in TD-SCDMA system is limited, the present invention takes advantage of midamble and downlink synchronization code to estimate the frequency difference between LO signals and carrier of the received signals in the receiver, and then tunes the frequency of LO signals with the difference so as to keep it consistent with the frequency of the received signals.

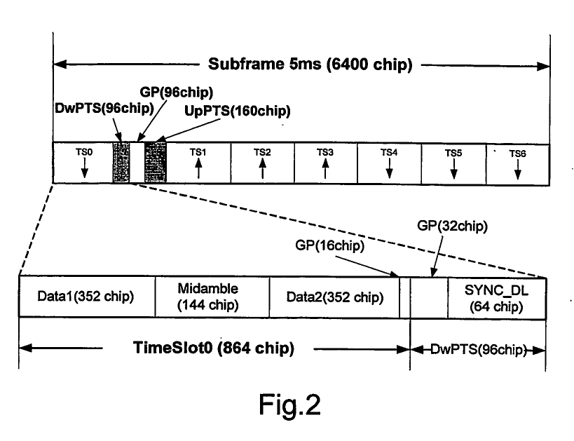

To fully understand the embodiments of the present invention, especially why frequency estimation can be done in the present invention only with limited midamble and downlink synchronization code, a brief introduction will be given to the sub-frame and traffic timeslot structures used by TD-SCDMA system in 3GPP standards in conjunction with FIG. 2. A summarized description will also go to cell search procedure, to explain how the midamble and downlink synchronization code used in the cell are acquired.

In TD-SCDMA system, a radio frame is 10 ms in duration, and every radio frame is further divided into two sub-frames. Each sub-frame is 5 ms in duration, or namely 6400 chips. As FIG. 2 illustrates, each sub-frame includes seven traffic timeslots TS0-TS6 and three special timeslots: DwPTS (downlink pilot timeslot), UpPTS (uplink pilot timeslot) and GP (guard period).

As the figure shows, each traffic timeslot is 675 μs in duration or namely 864 chips. Each traffic timeslot is divided into 4 fields, including data field 1 (352 chips), midamble field (144 chips), data field 2 (352 chips) and GP for timeslot guard (16 chips). Among the seven timeslots, TS0 is always used for carrying downlink data, TS1 is always used for carrying uplink data, and TS2-TS6 can be used for respectively carrying data in uplink or downlink.

Among the three special timeslots, DwPTS (96 chips) is located behind the first timeslot TS0, for carrying downlink pilot and synchronization channel code or namely downlink synchronization code (SYNC_DL), wherein SYNC_DL is 64 chips in duration and preceding it there are 32 chips of guard period. UpPTS (160 chips) is used for carrying uplink pilot and synchronization channel code or namely uplink synchronization code (SYNC_UL), to establish uplink synchronization between the UE and node B, wherein SYNC_UL is 128 chips in duration and there are 32 chips of guard period. GP is 96 chips, used for guarding Tx propagation delay during uplink establishment procedure.

In the above-mentioned introduction to the sub-frame and timeslot structures, SYNC_DL in DwPTS, SYNC_UL in UpPTS and midamble in traffic timeslot are given in form of chip rate straightforwardly, and thus will be delivered later along with the baseband processed and spread data directly without being baseband processed, spread and scrambled. DwPTS can be transferred all the while at a constant power that can ensure omni-direction coverage of the whole cell, so that all UEs in the cell can receive the synchronization information.

Moreover, SYNC_DL, SYNC_UL and midamble can be found directly in 3GPP specifications and thus need not be generated additionally. According to 3GPP specifications, there are 32 SYNC_DL codes, 256 SYNC_UL codes, 128 midamble codes and 128 scrambling codes defined in TD-SCDMA system. All these codes are classified into 32 groups, with each group having one SYNC_DL codes, 8 SYNC_UL codes, 4 midamble codes and 4 scrambling codes. Different adjacent cells use different code groups. For a UE, if the SYNC_DL code used by its cell is known, the four midamble codes used by its cell can also be decided. But only one midamble code is used in ordinary cells, and the other three are reserved for different operators. The 144 chips carried on the midamble field will be generated through cyclic shift based on the basic midamble codebook in 3GPP specifications. Midamble codes used by different channels in the same timeslot are obtained by intercepting different areas of the cycled basic midamble codebook, and different midamble shifts are usually denoted by m⁽¹⁾ m⁽²⁾ . . . m^{(m)}.

The above introduction goes to the structures and characteristics of the radio frame, sub-frame, timeslot and special codes on the physical layer of TD-SCDMA system. In a practical TD-SCDMA system, user data and control information are delivered in physical channels, and each physical channel is defined by many factors such as frequency, timeslot, channel code, midamble shift, allocation of radio frames and etc. Some physical channels at particular locations in the sub-frame will have particular physical characteristics, such as beacon characteristic. The so-called beacon characteristic means that the transmission characteristics can be analyzed and measured according to the features of the physical channel. Physical channels with beacon characteristic are also called as beacon channel.

In TD-SCDMA system, beacon channel appears in TS0 of each sub-frame, because common control physical channel is fixedly located in TS0 and uses some fixed parameters, for example, TS0 uses the first and second fixed channelization codes c_{Q=16}^{(k=1)} and c_{Q=16}^{(k=2)}, and fixed midamble codes m⁽¹⁾ and m⁽²⁾. If no antenna diversity is applied in the cell, the PCCCH (primary common control channel) will use m⁽¹⁾ only; if antenna diversity is applied in the cell, the PCCCH will use m⁽¹⁾ on the first antenna and m⁽²⁾ on the second antenna. Because TS0 uses fixed midamble code, users can easily obtain the midamble code used by the cell in TS0 after obtaining SYNC_DL during cell search procedure.

The detailed procedure for cell search is as follows: the UE first finds the most powerful frequency through measuring the broadband power of each carrier frequency in TDD frequency band. Afterwards, the UE receives information at the frequency and searches Dw PTS for determining SYNC_DL of the cell. Wherein, searching of SYNC_DL is generally done. by first determining the timeslot position according to DwPTS power characteristic, and then to determine SYNC_DL used by the cell and its accurate position by using M F (match filter). After SYNC_DL used by the cell is known, the four midamble codes used by the cell can also be determined. Because fixed channelization codes are used in TS0, the four midamble codes configured for the cell can be used in turn to compute channel impulse responses, and the maximum value one will be determined as the midamble code used by the cell, and thus the corresponding scrambling code can be determined.

After cell search procedure is complete, the midamble code in TS0 and SYNC_DL in DwPTS at this frequency can be determined uniquely. As shown in FIG. 2, between midamble code of TS0 and SYNC_DL, there are data field 2 (352 chips), GP (16 chips) and the GP in DWTPS (32 chips), and totally 352+16+32=400 chips. The known signals of the midamble and SYNC_DL can be obtained accurately, and the time interval between the midamble and SYNC_DL can be forecast according to the communication specifications, so a correlation operation can be performed on the middle 128 chips in the midamble and 64 chips in SYNC_DL, which is equivalent to perform frequency estimation on the signals whose time interval from the middle of the midamble to the middle of SYNC_DL is up to 504 chips. The 504 chips comprise: (i) 72 chips in the midamble: the middle 128 chips in the midamble (144 chips) are selected for correlation operation when frequency is estimated, and the 16 chips remained are evenly located at the two sides of the 128 chips, so there are 72 (64+8=72) chips from the middle of the midamble to data field 2; (ii) 352 chips of data field 2; (iii) 16 chips for GP between data field 2 and DwPTS; (iv) 32 chips for GP preceding SYNC_DL in DWPTS; (v) 32 chips of SYNC_DL: there are 32 chips from the end of GP in DWPTS to :the middle of SYNC_DL (64 chips). Thus, 72+352+16+32+32=504 (chips), which is almost equivalent to the 512-chip midamble signals for frequency estimation in existing UMTS TDD system, but only the 128-chip midamble and 64-chip SYNC_DL thereof need correlation operation. Therefore, the utilization of midamble code and SYNC_DL for frequency estimation can ensure that the signals sequence needed for frequency estimation has enough length (i.e. the accuracy of frequency estimation can be ensured), and have less complexity than the prior segmented frequency estimation.

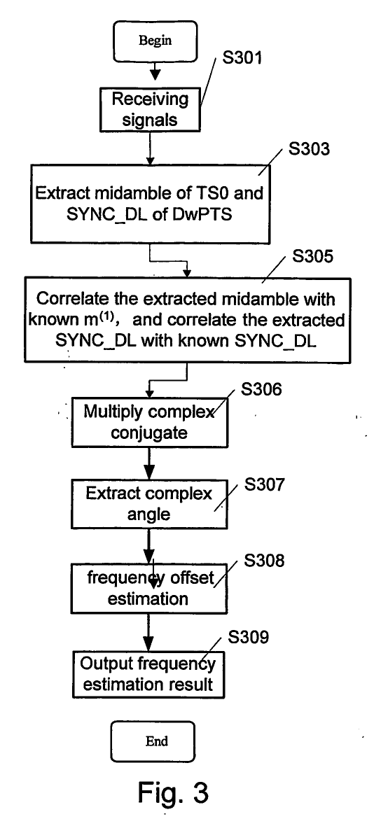

Based on the above ideas, the present invention proposes a downlink frequency estimation method for UEs, as shown in FIG. 3. In FIG. 3, first, the frequency estimation module receives baseband digital signals as the input signals (step S301), so as to extract midamble code in TS0 and SYNC_DL from the input signals.

Then, the midamble in TS0 is extracted from the received signal stream as normal, and SYNC_DL in DwPTS is extracted from the received signals by using MF (step S303). Afterwards, correlation operation will be applied on the extracted midamble and the midamble code m⁽¹⁾ determined in cell search procedure (assume that antenna diversity is not applied herein) (step S305). The result of the correlation operation is a complex vector, including phase shift between the received miamble and the known midamble. Meanwhile, a correlation operation will be done on the extracted SYNC_DL and the SYNC_DL acquired in cell search procedure, to get the phase shift between the received downlink synchronization signals and the known SYNC_DL. Then, a conjugation operation is performed on the phase shift of the acquired midamble, and the result is multiplied with the phase shift of the SYNC_DL, to get a conjugation product (step S306). The angle of the conjugation product represents the difference between the phase shift of the midamble and that of the SYNC_DL, i.e. the total mount of phase change from the middle of the midamble to the middle of the SYNC_DL.

In order to get the total phase difference, the angle needs to be extracted (step. S307). Extraction of the angle can be implemented in two ways. The first is to get accurate result through computing trigonometric function, but the computation is very complex. When the angle is small enough (much less than 1), the conjugation product can be scaled to a complex number in unit magnitude and the angle can be approximated by the imaginary part of the complex number. This is the second way.

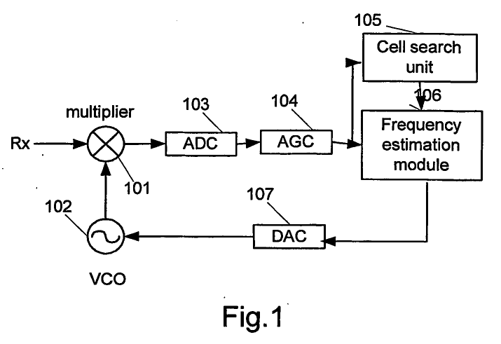

After the angle is obtained in step S307, the frequency change can be represented by phase change in unit time, because the angle of the conjugation product represents the total phase change from the midamble to SYDC_DL. In the present invention, the time between the middle of midamble in TS0 and SYNC_DL in DwPTS is 504 chips in duration. Namely, the time duration of 504 chips can be used to normalize the total phase shift, to estimate the frequency offset of the LO signals (step S308). Finally, result of the frequency offset estimation is outputted, for being processed by subsequent AFC (as shown in FIG. 1) (step S309).

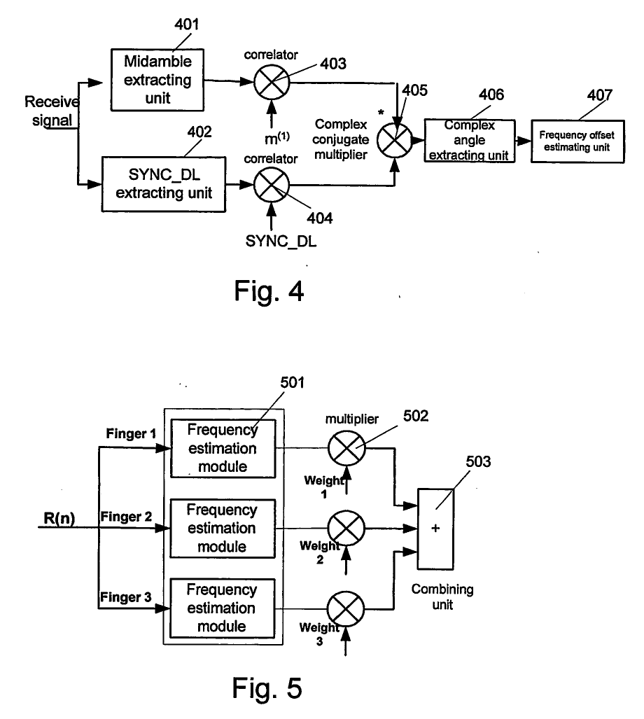

The proposed frequency estimation method can be implemented in software, as illustrated by FIG. 3, or in hardware, or in combination of both. FIG. 4 is a block diagram illustrating an embodiment of the frequency estimation module in accordance with the present invention.

In FIG. 4, the received signals is first divided into two paths, respectively inputted to TS0 midamble extracting unit 401 and SYNC_DL extracting unit 402, for extracting midamble and SYNC_DL from the received signals. Then, the extracted miamble is sent to the first correlator 403, to be correlated with the midamble m⁽¹⁾ determined in cell search procedure, to get a complex vector containing the phase shift between the received midamble and the known midamble. Similar to midamble signal processing, the SYNC_DL extracted from DwPTS is correlated with the SYNC_DL acquired in cell search procedure in the second correlator 404, to get the phase shift between the received uplink synchronization signals and the known SYNC_DL. Then, in multiplier 405, a conjugation multiplication is applied to the output result of the first correlator 403 and that of the second correlator 404, to obtain a conjugation product. That is, in multiplier 405, the output of the first correlator 403 is conjugated, and the result is multiplied with the output of the second correlator 404. The angle of the conjugation product is the phase shift between the complex vectors outputted by the two correlators, or namely the total phase change from the middle of the midamble to the middle of the SYNC_DL. After the conjugation product is processed by the angle extracting unit 406, we can get the total phase change of received signals in time duration of 504 chips. The angle extraction method is the same as the aforementioned method as shown in FIG. 3, with accurate result through computing trigonometric function, or approximate result through scaling the conjugation product to a complex number in unit magnitude. Angle extracting unit 406 feeds the extracted angle to frequency offset estimation unit 407, for normalizing the total phase shift represented by the angle with a time duration of 504 chips, to get the result of frequency offset estimation.

The above section gives a detailed description to the working principle and architecture of the proposed frequency estimation module. The frequency estimation module can be applied in many cases. For example, it can be used alone in the closed-loop AFC structure as shown in FIG. 1, for feedback controlling the output signals frequency of the VCO, or combined with a Rake receiver to get more accurate estimation, or alternatively applied in multi-antenna systems, i.e. being located behind each antenna, to improve the gain of spatial diversity.

FIG. 5 is a block diagram illustrating the Rake receiver with the frequency estimation module proposed in the present invention. As FIG. 5 shows, the received signals are divided into several branches, and frequency estimation module 501 computes the frequency offset independently on each finger of the Rake receiver. Then, in multiplier 502, the frequency offset estimated by each finger is multiplied with the corresponding weight factor, and combined finally at combining unit 503, to get a frequency offset estimation signals containing frequency offset estimation result of each finger. Combining unit 503 can accomplish combination by using many methods, such as EGC (equal gain combining), MRC (maximum ratio combining) and so on. The architecture as shown in FIG. 5 combines the s everal independently computation amounts of frequency offset to get a final frequency offset estimation signals, rather than computes the frequency offset through combining the several branches of signals, which adds the computation complexity a little bit, but can improve the accuracy of frequency estimation greatly.

When applied in multi-antenna systems, the proposed frequency estimation module has similar architecture with FIG. 5, with the only difference that the several fingers of the Rake receiver are replaced by multiple antenna elements.

Beneficial Results of the Invention

Regarding to the method and apparatus for estimating downlink frequency offset in TD-SCDMA system in accordance with the present invention, midamble in TS0 and SYNC_DL in DWPTS are utilized to estimate the frequency offset of the LO signals. The proposed frequency estimation method obtains the frequency offset in 504-chip duration by only computing the 128-chip midamble and the 64-chip SYNC_DL, thus greatly simplifies the computation complexity in segmented estimation procedure and saves computation time, compared with prior frequency estimation method of using the 512-chip signals in a timeslot. In the present invention, the known signals for the midamble and SYNC_DL can be acquired respectively, and correlated, thus higher accuracy and more robust performance can be attained than prior frequency estimation methods.

Moreover, when the proposed frequency estimation method is combined with Rake receiver, frequency estimation is performed in each finger independently and then weighted and combined, thus it can overcome the inaccuracy caused by multipath interference. When integrated with. multi-antenna systems, the proposed method in this invention can maintain good system performance even in the presence of large delay spread.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of frequency estimation for the downlink of wireless communication systems, comprising:
(a) according to the received radio signals, determining radio signals the phase shift of the midamble and that of the downlink synchronization code of the radio signals respectively;
(b) calculating the phase shift difference between the midamble and the downlink synchronization code of the radio signals, according to the determined phase shift of the midamble and that of the downlink synchronization code;
(c) estimating the frequency offset of the radio signals, according to the phase shift difference between the midamble and the downlink synchronization code of the radio signals and the relationship between the expected midamble and the downlink synchronization code.

2. The method of claim 1, wherein the relationship between the expected midamble and the downlink synchronization code is the time interval between the expected midamble and the downlink synchronization code.

3. The method of claim 2, wherein step (a) includes:
(a1) extracting the midamble of the radio signals from the radio signals;
(a2) acquiring the midamble used by the cell during cell search procedure;
(a3) correlating the midamble of the radio signals with the acquired midamble used by the cell, to determine the phase shift of the midamble of the radio signals.

4. The method of claim 3, wherein step (a) includes:
(a4) extracting the downlink synchronization code of the radio signals from the radio signals;
(a5) acquiring the downlink synchronization code used by the cell through cell search procedure;
(a6) correlating the downlink synchronization code of the radio signals with the acquired downlink synchronization code used by the cell, to determine the phase shift of the downlink synchronization code of the radio signals.

5. The method of claim 4, wherein step (b) includes:
(b1) conjugating the phase shift of the midamble of the radio signals;
(b2) multiplying the conjugate of the phase shift of the midamble by the phase shift of the downlink synchronization code;
(b3) acquiring the phase shift difference between the midamble and the downlink synchronization code of the radio signals from the multiplication result.

6. The method of claim 5, wherein the complex angle of the multiplication result is extracted through calculating trigonometric functions and the value of the complex angle is taken as the phase shift difference between the midamble and the downlink synchronization code of the radio signals, in step (b3).

7. The method of claim 5, wherein the multiplication result is converted into complex in unit amplitude and the imaginary part of the complex is taken as the phase shift difference between the midamble and the downlink synchronization code of the radio signals, in step (b3).

8. The method of claim 6, wherein step (c) includes:
normalizing the phase shift difference between the midamble and the downlink synchronization code, to get the frequency offset of the radio signals, according to the time interval between the expected midamble and the downlink synchronization code.

9. An apparatus of frequency estimation for the downlink of wireless communication systems, comprising:
a determining unit, for determining, according to the received radio signals, the phase shift of the midamble and that of the downlink synchronization code of the radio signals respectively;
a calculating unit, for calculating the phase shift difference between the midamble and the downlink synchronization code of the radio signals, according to the determined phase shift of the midamble and that of the downlink synchronization code;
an estimating unit, for estimating the frequency offset of the radio signals, according to the phase shift difference between the midamble and the downlink synchronization code of the radio signals and the relationship between the expected midamble and the downlink synchronization code.

10. The apparatus of frequency estimation in claim 9, wherein the relationship between the expected midamble and the downlink synchronization code is the time interval between the expected midamble and the downlink synchronization code.

11. The apparatus of frequency estimation in claim 10, wherein the determining unit includes:
a midamble acquiring unit, for extracting the midamble of the radio signals from the radio signals;
a first correlator, for correlating the midamble of the radio signals with the midamble used by the cell, to determine the phase shift of the midamble of the radio signals, wherein the midamble used by the cell is acquired through cell search procedure.

12. The apparatus of frequency estimation in claim 10, wherein the determining unit further includes:
a downlink synchronization code acquiring unit, for extracting the downlink synchronization code of the radio signals from the radio signals;
a second correlator, for correlating the downlink synchronization code of the radio signals with the downlink synchronization code used by the cell, to determine the phase shift of the downlink synchronization code of the radio signals, wherein the downlink synchronization code used by the cell is acquired through cell search procedure.

13. The apparatus of frequency estimation in claim 12, wherein the calculating unit includes:
a complex conjugate multiplier, for conjugating the phase shift of the midamble of the radio signals, and multiplying the conjugate of the phase shift of the midamble by the phase shift of the downlink synchronization code;
a phase shift difference calculating unit, for acquiring the phase shift difference between the midamble and the downlink synchronization code of the radio signals from the multiplication result.

14. The apparatus of frequency estimation in claim 13, wherein the phase shift difference calculating unit extracts the complex angle of the multiplication result by calculating trigonometric functions, and takes the value of the complex angle as the phase shift difference between the midamble and the downlink synchronization code of the radio signals.

15. The apparatus of frequency estimation in claim 13, wherein the phase shift difference calculating unit converts the multiplication result into complex in unit amplitude and takes the imaginary part of the complex as the phase shift difference between the midamble and the downlink synchronization code of the radio signals.

16. The apparatus of frequency estimation in claim 14, wherein the estimating unit normalizes the phase shift difference between the midamble and the downlink synchronization code of the radio signals, to get the frequency offset of the radio signals, according to the time interval between the expected midamble and the downlink synchronization code.

17. A radio signal receiver, comprising:
a receiving unit, for receiving radio signals and converts the received radio signals into baseband digital signal;
a cell searching unit, for performing cell search procedure based on the received signal, to get the midamble and the downlink synchronization code used by the cell;
a frequency estimating unit, for determining the phase shift of the radio signals according to the received radio signals and the midamble and the downlink synchronization code used by the cell outputted by the cell searching unit;
a frequency generating unit, for adjusting the output frequency supplying to the receiving unit according to the inputted frequency offset information, so that the receiving unit can convert the received radio signals into baseband digital signal by using the adjusted frequency.

18. The radio signal receiver in claim 17, wherein the frequency estimating unit includes:
a determining unit, for determining, according to the received radio signals, the phase shift of the midamble and that of the downlink synchronization code of the radio signals respectively;
a calculating unit, for calculating the phase shift difference between the midamble and the downlink synchronization code of the radio signals, according to the determined phase shift of the midamble and that of the downlink synchronization code;
an estimating unit, for estimating the frequency offset of the radio signals, according to the phase shift difference between the midamble and the downlink synchronization code of the radio signals, and the relationship between the expected midamble and the downlink synchronization code.

19. The radio signal receiver in claim 18, wherein the determining unit includes:
a midamble acquiring unit, for extracting the midamble of the radio signals from the radio signals;
a first correlator, for correlating the midamble of the radio signals with the midamble used by the cell, to determine the phase shift of the midamble of the radio signals;
a downlink synchronization code acquiring unit, for extracting the downlink synchronization code of the radio signals from the radio signals;
a second correlator, for correlating the downlink synchronization code of the radio signals with the downlink synchronization code used by the cell, to determine the phase shift of the downlink synchronization code of the radio signals.

20. The radio signal receiver in claim 19, wherein the calculating unit includes:
a complex conjugate multiplier, for conjugating the phase shift of the midamble of the radio signals, and multiplying the conjugate of the phase shift of the midamble by the phase shift of the downlink synchronization code;
a phase shift difference calculating unit, for acquiring the phase shift difference between the midamble and the downlink synchronization code of the radio signals, by calculating trigonometric functions or converting the multiplication result into complex in unit amplitude.

21. The radio signal receiver in claim 20, wherein the estimating unit normalizes the phase shift difference between the midamble and the downlink synchronization code to get the frequency offset of the radio signals, according to the time interval between the expected midamble and the downlink synchronization code.

22. A Rake receiver, comprising:
a receiving unit, for receiving radio signals, and dividing the radio signals into a plurality of fingers of signals;
a plurality of frequency estimating modules, for estimating the frequency offset of each finger of signal respectively;
a weighting and combining unit, for weighting the signal outputted from each frequency estimating module and combining the weighted signal to get a frequency offset estimating signal containing frequency offset estimation result about each finger.

23. The Rake receiver in claim 22, wherein each the frequency estimating module includes:
a determining unit, for determining, according to the received radio signals, the phase shift of the midamble and that of the downlink synchronization code of the radio signals respectively;
a calculating unit, for calculating the phase shift difference between the midamble and the downlink synchronization code of the radio signals, according to the determined phase shift of the midamble and that of the downlink synchronization code;
an estimating unit, for estimating the frequency offset of the radio signals, according to the phase shift difference between the midamble and the downlink synchronization code of the radio signals and the relationship between the expected midamble and the downlink synchronization code.

24. A receiver with a plurality of antenna elements, comprising:
a receiving unit, for receiving a plurality of channels of radio signals via the plurality of antenna elements;
a plurality of frequency estimating modules, for estimating the frequency offset of each channel of radio signals respectively;
a weighting and combining unit, for weighting the signal outputted from each frequency estimating module and combining the weighted signals to get a frequency offset estimating signal containing frequency offset estimation result of each channel.

25. The receiver in claim 24, wherein each the frequency estimating module includes:
a determining unit, for determining, according to the received radio signals, the phase shift of the midamble and that of the downlink synchronization code of the radio signals respectively;
a calculating unit, for calculating the phase shift difference between the midamble and the downlink synchronization code of the radio signals, according to the determined phase shift of the midamble and that of the downlink synchronization code;
an estimating unit, for estimating the frequency offset of the radio signals, according to the phase shift difference between the midamble and the downlink synchronization code of the radio signals, and the relationship between the expected midamble and the downlink synchronization code.
